(19) United States
(12) Patent Application Publication
(10) Pub. No.: US 2007/0063075 A1
(43) Pub. Date: Mar. 22, 2007

(54) Wound debridement apparatus

(76) Inventor: Gary H. Kaplowitz, University Place, WA (US)

Correspondence Address: Gary H. Kaplowitz, 4216 Riobin Rd. W., Unicersity Place, WA, 98466, US

(21) Appl. No.: 11/233,443

(22) Filed: Sep. 21, 2005

(51) Int. Cl. B05B 1/30

(52) U.S. Cl. 239/581.1

(57) ABSTRACT

A hydrotherapy mechanical wound irrigation device for successful use with domestic water pressure service for the performance of wound self maintenance. The apparatus contains a body that is adapted to a domestic water connection, allowing for concurrent device and domestic plumbing fixture usage. The body contains a valve mechanism with lever for regulating flow through the device and spray nozzle whose specifications afford desirable impact pressures across the full range of domestic water pressures encountered.

### FIELD OF INVENTION

This invention relates to hydrotherapy mechanical wound irrigation devices, and most specifically to fluid spraying devices within the art intended for home usage by the patient for self management wound cleansing and debridement.

### BACKGROUND OF THE INVENTION

In the crowded and diverse art of hydrotherapy mechanical wound irrigation devices, very few inventions are provided for home usage. The use and recognized benefits of hydro-mechanical wound cleansing have long been recognized in the art as an effective means for both disinfection, removal of necrotic tissues, the promotion of circulation and accelerated healing. However, the prior arts offerings have been complex assemblies that are time consuming to assemble and not user friendly to non-professional patients who would ideally be performing self maintenance of their wounds. Even within the realm of clinically applied hydro-mechanical wound irrigation, large volumes of saline or other medicated mixtures are found to be necessary to afford effective sanitizing of wound sites. Further, the lack of cost effective, user friendly home use wound cleansing devices has caused an unnecessarily higher rate of infections, related complications and resulting overall per capita medical treatment costs. These disadvantages in turn have resulted in higher patient billings and insurance premium rate levels. Within the realm of hydro-mechanical therapy, with the possible exception of whirlpool hydrotherapy, the higher pressures associated with conventional fluid spraying applicators, while effective in the debridement of wounds, also can be quite painful to the patient and tend to macerate new tissue further delaying the healing process.

Examination will be primarily focused, therefore, on these fluid spraying devices within the art intended for home usage by the patient for wound self management. Marasco Jr., U.S. Pat. No. 5,848,998 & Marasco et al, U.S. Pat. Nos. 6,083,209 and 6,635,035 all present relatively complex devices for use in home, field or “outside of a formal medical facility”. Marasco Jr., U.S. Pat. No. 5,848,998 introduces a complex kit assembly 10, comprising multiple elongated tube wands 25, medicaments “M”, gas canisters “C” brush or sponge applicator nozzle attachments 29, containment bags 12 and a reservoir or suction or pump assembly 40. Marasco et al further presents in U.S. Pat. No. 6,635,035 and similarly in U.S. Pat. No. 6,083,209 a motorized fluid transfer pump 50 that directs various fluid or fluid/gas fluid medicaments to a contained wound site and a suction pump 62 that creates “a vacuum incentive for drainage of fluids within a patient enclosure bag 34 that contains the contaminated fluid medicament” along with a similar array of hoses, containment bags other components. While Marasco's inventions afford a means of splatter containment and the resulting risk of spreading infection from wound to wound in patients with multiple wounds, all of forms of his inventions are complex, costly to manufacture, generally impractical for personalized treatment at home, include separate containment reservoirs creating a consequent disposal requirement and presents a potential biomedical hazard to the environment. Another invention in the broader field of hydrotherapy mechanical wound cleansing and debridement devices that include the efficacy of atomized particle flow is Babaev, U.S. Pat. No. 6,569,099. Babaev presents several advantages to his ultrasonically powered wound treatment device. Babaev's device affords access to relatively inaccessible wound sites due to the fine particle size delivered without physical or direct instrument contact. Babaev's device also has the advantage of decreasing wound healing times for inflammatory and purulent infected wounds due to the bactericidal and blood flow increasing effect of these atomized particles. While Babaev's invention is not disclosed for home usage, it serves as an example of innovative, relatively complex technology applied to the art that belongs in the hands of professionals within a clinical environment. Babaev's invention comprises of numerous components including an ultrasound wave generator 4, an ultrasound transducer 6, a cable 8, a wave generator 4 whose front panel 10 includes a power button 12, a timer 14, a control button 16, one or more displays 18, one or more jacks 20 for a footswitch, a nozzle 22, a liquid reservoir 24 and others. The cost to produce this for outpatient usage would be prohibitive and the complexity of use would be beyond the realm of practicality for the average non-professional to use. Moreover, Babaev provides no means of containment of the spray. Another complex device for clinical and not home usage is Henninges et al., U.S. Pat. No. 6,471,668. While not anticipated for home usage, Henninges' invention is also a complex assembly, comprising of an irrigator hand piece 22 containing an electric motorized pump 24, a power chord 42 that connects to a battery power source 38, a supply tube 28 connected to a fluid storage bag 26, suction tube 50 and an undefined suction system 46 that would further require a separate power source and a means of disposal of contaminated fluid medicament. Henninges' spray shield 181 while also affording splatter containment is just an additional part of an already complex assembly. Henninges' invention is also complex to use and prohibitively costly to manufacture if prescribed within the context of outpatient home usage. The art is in dire need of a simpler home usage hydrotherapy wound debridement device that makes use of domestic water pressure for usage and universally available residential domestic plumbing fixtures and waste system to dispose of contaminated fluids. One such domestic water powered device used within the unrelated art of water jet flossing for use in shower, sink or hose bib is Kaplowitz, U.S. Pat. No. 6,740,053. This device contains a jet tip 14 with defined tip acutely bent to prevent the user's throat from being inundated with water, thus mitigating a gagging potential inherent with the higher flow rates encountered with domestic water connections. Kaplowitz' invention, eliminated the need for a motorized pump unit and makes use of a sink or shower fixture for the purposes of waste water disposal. Kaplowitz, while affording a similar benefit of concurrent shower usage while in the performance of oral hygiene, does not teach, anticipate nor in any way disclose this device for the purpose of wound debridement. The present invention, while offering all the aforementioned advantages of the prior art, also affords the additional benefits of spray containment and disposal inherent to shower usage wherein a bathtub drain and shower curtain & tub serve these needs without the need to include them separately within the device itself. Another object of the present invention is to provide the user with a simple and safe device for home usage that will minimize the pain or tissue damage associated with excessive fluid delivery impact pressures. Those with open wounds are naturally reluctant to any potentially painful, intrusive wound contact. This is especially true of those who have had this type of debridement performed by the clinician and have experienced the pain associated with it. Therefore, the patient would be consequently reluctant to perform self wound maintenance unless they can be provided with, and assured of, their ability to monitor and control the fluid delivery pressure and temperature with their associated pain potential. The present invention's preferred embodiment addresses this need by delivering a relatively uniform and lower pressure profile that can be directly varied by varying spray distance from the wound. Moreover, the spray nozzle of the present invention delivers a uniform impact pressure within an optimal pressure range regardless of domestic service water pressures that fall within the characteristic 30 to 90 pound per square inch (psi) range. Lower pressure also reduces the danger of tissue maceration and painful irritation to the wound site which is a widely recognized disadvantage of the prior hydrotherapy debridement art. The present invention also affords the additional benefits of vasodilatation, increased blood flow, softening of necrotic tissue and topical agent removal provided by whirlpool hydrotherapy combined with the similarly fine droplet delivery of Babaev's invention affording access to relatively inaccessible wound sites and bactericidal activity without physical or direct instrument contact. Further, the present invention's means of temperature control using shower faucets is also universally familiar to the user. Thus the present invention affords an intuitively simple and universally understood fluid delivery temperature and pressure control methodology for the user. Since temperature and pressure control methodology of the present invention is familiar and not foreign to the user, as would be for the users of Marasco's invention U.S. Pat. No. 6,635,035 with its separate pressure and temperature controls, the user will be more likely to use it at home as prescribed by their doctor. The current invention can also deliver, what is also understood within the art, an optimal hydrotherapy temperature range of 92 to 96 deg. F. so as to minimize the risk of tissue maceration. The present invention provides a simple, inexpensive and practical home usage device that provides the aforementioned benefits using domestic water pressure, debrides necrotic tissue, stimulates circulation for reduced healing times, affords simple operation that is practical for outpatient home wound self maintenance with reduced wound irritation due to lower and uniform pressure delivery. These and other objects and advantages are elaborated below.

### SUMMARY OF THE INVENTION

The present invention, in its preferred embodiment, is a shower mounted hydrotherapy mechanical wound irrigation device affording the following advantages while overcoming the shortcomings of the prior art;
a) A hydrotherapy mechanical wound irrigation device whose simplicity of usage and ease of adaptability to existing threaded shower stub connections makes home wound self management practical and convenient within the realm of a normal bathing regimen;
b) A hydrotherapy mechanical wound irrigation device whose low cost of manufacture makes it a practical and affordable self treatment device whose medical risk management solution reduces the overall medical, insurance and ultimately consumer co-pay & premium costs associated with wound maintenance;
c) A hydrotherapy mechanical wound irrigation device whose concurrent shower head usage affords a sanitizing affect to possible additional wounds beyond the treatment zone, thus reducing the chances of cross contamination between wounds;
d) A hydrotherapy mechanical wound irrigation device whose ease of use and cost make both the prescription by the medical community and actual use by patients more likely thus reducing the likelihood of infection and other complications resulting in prolonged, more extensive and costly medical treatment, further insurance cost and resulting premium and co-pay increases;
e) A hydrotherapy mechanical wound irrigation device that affords the reduced healing time, bactericidal benefits of Babaev's atomized flow and access to relatively inaccessible wound sites due to the fine fan spray pattern delivered without physical or direct instrument contact but without the Babaev's need for an electrical power source;
f) A hydrotherapy mechanical wound irrigation device whose use in shower or alternately in a sink usage affords a direct draining of contaminated water. This is a significant improvement over Marasco's invention requiring a closure bag 34 or Henninges' invention requiring a separate suction system 46 and subsequent waste disposal;
g) A hydrotherapy mechanical wound irrigation device whose use with domestic hot and cold water faucets eliminates the need to include a separate heating temperature and flow source and control inherent to the device itself. This also affords the benefit of a familiar intuitively simple means of providing optimal fluid temperature delivery with reduced cost and complexity over Marasco's invention that requires both a temperature control mechanism and fluid delivery pump.
h) A hydrotherapy mechanical wound irrigation device whose cost effectiveness and the familiarity of delivery and temperature control benefits improve the likelihood of outpatient usage of the present invention. Another significant improvement over the aforementioned prior art;
i) A hydrotherapy mechanical wound irrigation device whose use with domestic hot and cold water faucets can deliver the optimal 92 to 96 degree F. delivery temperature recognized within the art to prevent tissue maceration;
j) A hydrotherapy mechanical wound irrigation device whose low delivery impact pressure falls within an acceptable range recognized within the art within the full range of domestic water pressures encountered, affording effective wound cleansing with reduced pain and the danger of tissue maceration to the user;
k) A hydrotherapy mechanical wound irrigation device whose uniform pressure profile and whose intuitively simple distance/pressure relationship affords maximum pain control to the end user. The familiar and simple nature of pressure controls further encourages the end user to overcome reluctance to actually use the device.

### BRIEF DESCRIPTION OF THE DRAWINGS

FIG. 1 shows the preferred embodiment of the Wound Debridement Apparatus adapted for use in a shower.

FIG. 2 shows an end view of adapter 11.

FIG. 3 shows an enlarged section taken through adapter 11.

### DETAILED DESCRIPTION OF PREFERRED EMBODIMENT

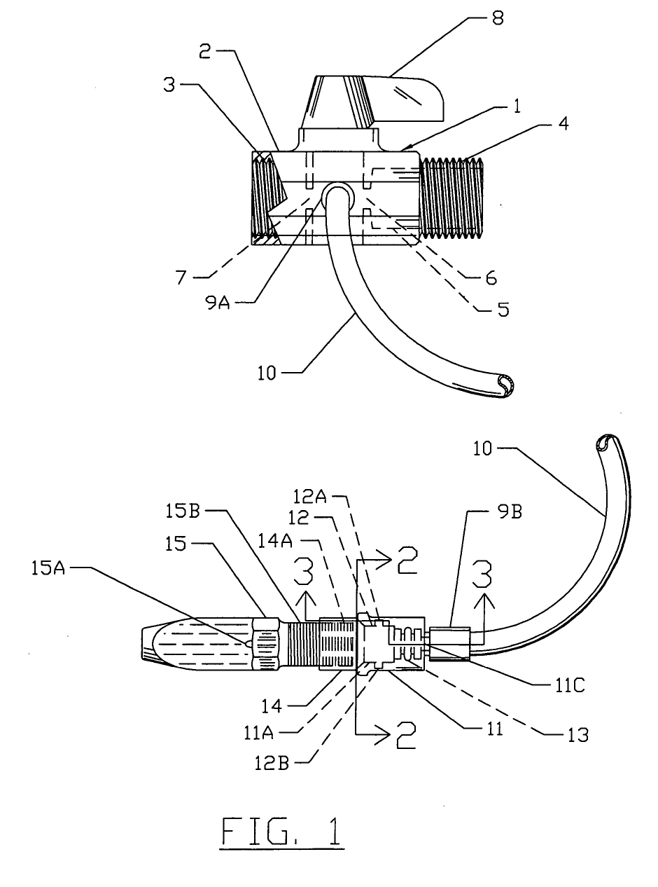

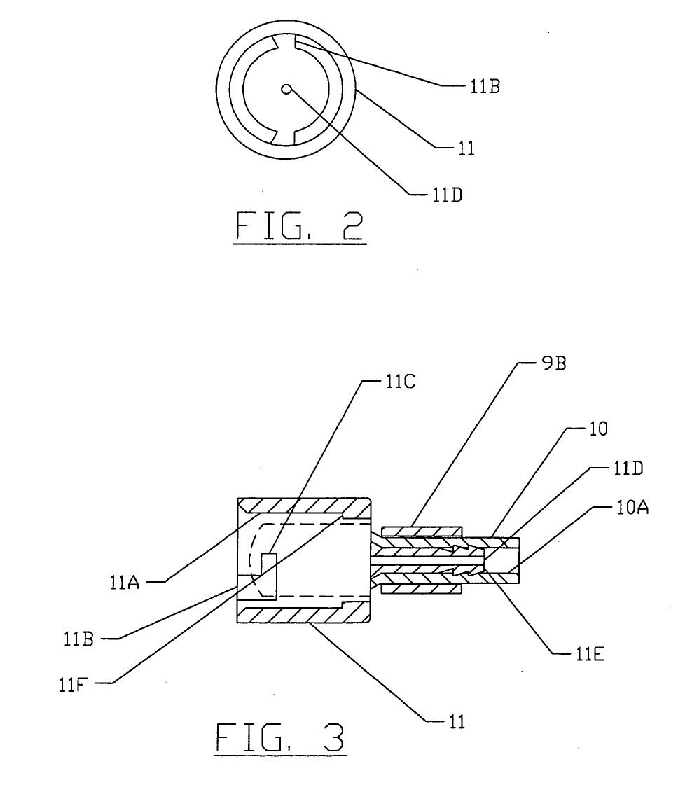

Certain terminology is used herein for convenience only and is not to be taken as a limitation on the present invention. Referring to FIGS. 1, 2 and 3, FIG. 1 shows the Wound Debridement Apparatus 1. One end of shower connector valve body 2 has a female threaded orifice 3, providing a standard threaded plumbing connection to a showerhead stub. The opposite end of body 2 also has a male standard threaded connection 4 to accommodate a showerhead. Connection 4 contains an opening 5 for passage of water through the shower head for concurrent wound maintenance and shower usage. Orifice 6 is sized for optimal velocity and flow through body 2. Orifice 7, sized similarly for optimal velocity, regulates and receives flow of water into body 2. Concurrently, a flow-regulating disk, well known to the art as commercially available from Vernay Laboratories Inc. of Yellow Springs, Ohio, part number VL3001-379, may be further employed to provide additional flow regulation for applications where very high domestic pressures are encountered. Valve lever 8 provides fine adjustment and regulating of the flow rate through the device independent of the faucet settings and is connected to a standard ball valve mechanism that is well know in the art, is not shown for clarity, and is not an object of the present invention. Inner Hose Surface 10A of Hose 10 (see FIG. 3) connects to body 2 using a standard laboratory type, tapered, and ribbed tube connector, not shown, similar to that shown in FIG. 3 as connector 11E. This connector creates interference fit with hose 10 to prevent leakage during use. Nylon bushing 9A slips over hose 10 further securing hose 10 to the standard hose connector and ultimately to body 2. Hose 10 is fabricated of a flexible and durable material capable of handling the full range of domestic water pressures encountered, which is generally 30 to 90 psig and is of sufficient length for user access to any bodily wound while standing or sitting within the shower. The opposite end of hose 10 is similarly secured to hose adapter 11 using a standard laboratory, tapered, ribbed tube connector 11E (FIG. 3.) Connector 11E creates an interference fit with Surface 10A. Orifice 11D allows flow through connector 11E. Nylon bushing 9B, in like manner, slips over hose 10, further securing the opposite end of hose 10 to hose adapter 11. Referring to FIG. 1 and FIG. 3, hose adapter 11 contains an orifice 11A that receives boss 12 from spray nozzle adapter 14. Nozzle adapter 14 is rotated inside of orifice 11A until the nib 12A and 12B of nozzle adapter 14 contacts slot stop 11C. When so joined, “O” ring 13, located on boss 12, of nozzle adapter 14, creates a tight seal between adapter 11 and boss 12 by firm contact of “O” ring 13 with step 1° F. Referring to FIG. 1 and FIG. 3, nozzle adapter 14 has a female threaded end 14A that receives the male threaded end 15B of a spray nozzle 15 similar to that shown as nozzle 10 in Kennedy et al, U.S. Pat. No. 4,721,250. Kennedy's invention, an apparatus for effecting humidity control has had wide usage in adiabatic humidification systems within the heating ventilating and air conditioning (HVAC) industry. The small orifice 13 of Kennedy's invention's preferred embodiment is 10 microns in diameter creating a very fine fog dilution in the air stream or environ applied. The resulting delivery pressure of Kennedy's nozzle 10 is too low for practical use in the present invention, but is disclosed herein as the type of nozzle referred to in the present invention. Such nozzles and variants thereof are currently manufactured by Bex Incorporated, Livonia Mich., PNR America, Poughkeepsie, N.Y. and by others. These and other manufacturers of spray nozzles afford different configurations with various orifice sizes and spray patterns for uses in a variety of industrial applications unrelated and unobvious to those of average skill within the present art. One pattern includes a fan spray pattern with lighter peripheral than central pressure to allow for overlapping but uniform industrial process finish applications. Another pattern provides an angled fan deflection affording a low impact wide angled spray, used for industrial rinsing and cooling and other applications. Another pattern, as shown in Kennedy's invention provides a uniform conical atomized diffusion as is used in humidification for environmental control. Where yet another can provide a hollow cone pattern. For the application at hand of the present invention, it is necessary to choose a higher impact nozzle within that art since the water pressures available from domestic service water, customarily 30 to 90 lbs. per square inch gage (psig), are considerably less than those obtainable by a compressor and/or pump which can deliver hundreds of psig of service pressure. Nozzle 15 shown in FIG. 1, within the preferred embodiment of the present invention utilizes a flat fan-shaped spray with sharp definition and the aforementioned uniform pressure profile at any horizontal cross section taken perpendicular to the flow. The pressure profile also varies directly with the distance from the nozzle orifice 15A as indicated above in the background of the invention. Moreover, due to the aforementioned varying range of domestic water service pressures of 30 to 90 psig, the field of usable nozzle spray patterns is narrowed to those with higher flow and impact pressure ranges and larger orifices so as to deliver adequate flow and delivery impact pressure within an optimal range for the prior art of the present invention. The art has recognized that an effective delivery pressure for debridement will vary upon the type and stage of wound healing. While it is not desirable to have anything but a moist environ for wounds that are undergoing the early stages of epithelial migration in full thickness wounds, for wounds benefiting from debridement to remove basal necrotic tissue a minimum delivery pressure of 10 psig to a maximum pressure of 40 psig have been found to be effective for debridement, particularly when delivered at the optimal 92 to 96 deg. F. temperature range. The preferred embodiment orifice 15A size that delivers that capability within the full range of the aforementioned domestic water service pressures encountered is 0.08″ diameter. The flat fan spray pattern profile also has identical, uniform delivery pressures from angularities of 15 to 50 degrees. The typical domestic water system velocity and capacity of the tubing is also an important control parameter to limit flow rates, as higher flows create a higher than optimal delivery impact pressures. For the present invention's preferred embodiment, hose 10 is ¼″ diameter flexible plastic or hard rubber tubing of 4 to 6 feet in length whose design flow capacity is from 1.2 gpm at and 8 feet per second (fps) flow rate to a maximum of 1.5 gpm delivered at 10 fps. Testing has shown that a flow rate from 0.9 gpm to 1.2 gpm can be maintained while delivering the optimal 10 to 40 psig impact pressure recognized in the art. While a nozzle orifice 15A size of 0.07 to 0.11 is workable it is less than ideal for the purposes of uniform delivery flow rate and delivery pressures as herein disclosed. Specifically, it was found that for service pressures at the higher end of the range of 80 to 90 psig, there is a potential for higher than optimal delivery impact pressures of 48 to 56 psi respectively when using the 0.11 diameter orifice. Further, sub-optimal delivery pressures of 6.6 psi to 9.3 psi were delivered at the lower range of 30 to 45 psi service pressures with the 0.07″ orifice. Since the device is to be used in home, it is important that radical variations of flow and pressure rates be avoided to prevent possible injury due to excessive impact pressures or ineffectiveness for debridement at those delivery pressures below the optimal range. Dependent upon the type and nature of the wound to be treated, a physician's prescribed treatment regimen and device usage demonstration would be provided patients to assure that correct usage, duration of treatment and efficacious delivery pressure settings are established prior to patient use. It should be understood that home debridement would utilize a topical anesthetic as is customarily used in the art, such as EMLA, which can be prescribed by a physician to an outpatient to numb the wound site prior to performing self wound maintenance. It is to be understood that the form of the invention herein shown and described is to be taken as a preferred example of the same. Various changes in the shape, size, materials and arrangements of parts may be resorted to without departing from the spirit of the invention or the scope of the appended claims. Many other variations are possible. Consistent with the aforementioned concurrent sink and faucet usage scenario, the adaptation of this device for threaded connection to a domestic sink faucet could be utilized in lieu of a shower head stub by varying the threaded end 3 or by providing threaded adaptors to match accommodate the various sink faucet standard threading encountered.

1. A shower mounted hydrotherapy mechanical wound irrigation device comprised of;
a) a valve body means adapting shower head and device;
b) said body having a standard, female threaded end means connecting to a standard shower head stub and a standard, male threaded end means connecting to a shower head;
c) said body having a lever regulating device flows and concurrent shower and device usage;
d) said body having an inlet orifice and an outlet orifice, sized to regulate flow rates through said body;
e) said body having a tube connector means receiving a hose;
f) a concentric collar means securing said hose to said tube connector;
g) said hose having an opposite end;
h) a hose adaptor;
i) said hose adaptor having a second tube connector means receiving said opposite hose end;
j) a second concentric collar means securing said opposite hose end to said second tube connector;
k) a nozzle adaptor;
l) said hose adapter having an orifice means receiving a boss end of said nozzle adaptor;
m) said boss end having an inlet orifice;
n) said boss end having an “O” ring means sealing connection of said boss end within said hose adapter orifice;
o) a spray nozzle;
p) said nozzle adapter having an threaded orifice means receiving a threaded end of said spray nozzle;
q) said threaded end of said spray nozzle having an inlet orifice;
r) said spray nozzle having an outlet orifice.

2. The shower mounted hydrotherapy mechanical wound irrigation device of claim 1 wherein the spray nozzle is made of stainless steel.

3. The shower mounted hydrotherapy mechanical wound irrigation of claim 1 wherein the hose is made of flexible plastic.

4. The shower mounted hydrotherapy mechanical wound irrigation of claim 1 wherein the hose is made of flexible rubber.

5. A domestic water pressure driven hydrotherapy mechanical wound irrigation device comprised of;
a) a valve body means adapting threaded domestic water connection and device;
b) said body having a lever means regulating device flows and concurrent domestic water source and device usage;
c) said body having an inlet orifice and an outlet orifice, sized to regulate flow rates through said body;
d) said body having a tube connector means receiving a hose;
e) a concentric collar means securing said hose to said tube connector;
f) said hose having an opposite end;
g) a hose adaptor;
h) said hose adaptor having a second tube connector means receiving said opposite hose end;
i) a second concentric collar means securing said opposite hose end to said second tube connector;
j) a nozzle adaptor;
k) said hose adapter having an orifice means receiving a boss end of said nozzle adaptor;
l) said boss end having an inlet orifice;
m) said boss end having an “O” ring means sealing connection of said boss end within said hose adapter orifice;
n) a spray nozzle;
o) said nozzle adapter having an threaded orifice means receiving a threaded end of said spray nozzle;
p) said threaded end of said spray nozzle having an inlet orifice;
q) said spray nozzle having an outlet orifice.

6. The domestic water pressure driven hydrotherapy mechanical wound irrigation device of claim 5 wherein the threaded domestic water connection is a shower stub.

7. The domestic water pressure driven hydrotherapy mechanical wound irrigation device of claim 5 wherein the threaded domestic water connection is a sink faucet.

8. The shower mounted hydrotherapy mechanical wound irrigation device of claim 5 wherein the spray nozzle is made of stainless steel.

9. The shower mounted hydrotherapy mechanical wound irrigation of claim 5 wherein the hose is made of flexible plastic.

10. The shower mounted hydrotherapy mechanical wound irrigation of claim 5 wherein the hose is made of flexible rubber.
